(19) United States
(12) Patent Application Publication
(10) Pub. No.: US 2018/0293317 A1
(43) Pub. Date: Oct. 11, 2018

(54) PREFIX MATCHING USING DISTRIBUTED TABLES FOR STORAGE SERVICES COMPATIBILITY

(71) Applicant: NetApp, Inc., Sunnyvale, CA (US)

(72) Inventors: Blake Edwards, Vancouver (CA); Oliver Erik Seiler, New Westminster (CA); Robin Scott Mahony, Vancouver (CA); Tymoteusz Altman, Vancouver (CA)

(21) Appl. No.: 16/008,284

(22) Filed: Jun. 14, 2018

Related U.S. Application Data
(63) Continuation of application No. 14/338,296, filed on Jul. 22, 2014, now abandoned.

(51) Int. Cl. G06F 17/30

(52) U.S. Cl. CPC G06F 17/30864; G06F 17/30917; G06F 17/30678; G06F 17/30339; G06F 17/30117

(57) ABSTRACT

Technology is disclosed for enabling storage service compatibility. The technology can enable sorting of data stored across partitions, and provide for key splitting, e.g., to respond to data updates and additions.

### RELATED APPLICATIONS

This application is a continuation application of and claims priority to U.S. patent application Ser. No. 14/338,296 filed on Jul. 22, 2014, the entirety of which is incorporated herein by reference.

### BACKGROUND

Various entities are increasingly relying on “cloud” storage services provided by various cloud storage vendors and so many applications have been designed to employ application program interfaces (“APIs”) provided by these vendors. Presently, a commonly used cloud storage service is AMAZON's Simple Storage Service (“S3”). A second commonly employed cloud storage service is MICROSOFT AZURE.

Although entities desire to use these applications that are designed to function with one or more cloud service APIs, they also sometimes want more control over how and where the data is stored. As an example, many entities prefer to use data storage systems that they have more control over, e.g., data storage servers commercialized by NetApp, Inc., of Sunnyvale, California. Such data storage systems have met with significant commercial success because of their reliability and sophisticated capabilities that remain unmatched, even among cloud service vendors. Entities typically deploy these data storage systems in their own data centers or at “co-hosting” centers managed by a third party.

Data storage systems provide their own protocols and APIs that are different from the APIs provided by cloud service vendors and so applications designed to be used with one often cannot be used with the other. Thus, some entities are interested in using applications designed for use on cloud storage services but with data storage systems they can exercise more control over.

### BRIEF DESCRIPTION OF THE DRAWINGS

FIG. 1 is a block diagram illustrating an environment in which the disclosed technology may operate in some embodiments.

FIG. 2 is a table diagram illustrating tables employed by the disclosed technology in various embodiments.

FIG. 3 is a flow diagram illustrating a routine invoked by the disclosed technology in various embodiments.

FIG. 4 is a flow diagram illustrating a routine invoked by the disclosed technology in various embodiments.

### DETAILED DESCRIPTION

Technology is disclosed for prefix matching using distributed tables for storage services compatibility (“disclosed technology”). In various embodiments, the disclosed technology supports capabilities for enabling a data storage system to provide aspects of a cloud data storage service API. The technology may employ an eventually consistent database for storing metadata relating to stored objects. The metadata can indicate various attributes relating to data that is stored separately. These attributes can include a mapping between how data stored at a data storage system may be represented at a cloud data storage service, e.g., an object storage namespace. For example, data may be stored in a file in the data storage service, but retrieved using an object identifier (e.g., similar to a uniform resource locator) provided by a cloud storage service.

A commercialized example of an eventually consistent database is “Cassandra,” but the technology can function with other databases. Such databases are capable of handling large amounts of data without a single point of failure, and are generally known in the art. These databases have partitions that can be clustered. Each partition can be stored in a separate computing device (“node”) and each row has an associated partition key that is the primary key for the table storing the row. Rows are clustered by the remaining columns of the key. Data that is stored at nodes is “eventually consistent,” because in that other locations may be informed of the additional data (or changed data) over time.

Because data is partitioned and stored at different nodes, it can be difficult to retrieve the data in sorted order form. That is because each partition can retrieve data in a sorted form, but the data can be returned from the various partitions at different times and in different orders. Thus, returning sorted data quickly is difficult. In various embodiments, the technology employs key prefixes and full keys (or prefixes and suffixes together). A prefix identifies a partition and a suffix (or full key) can be used to retrieve data from the partition in a sorted manner.

In various embodiments, the technology creates and employs a “key_by_bucket” table to associate “buckets” of a cloud storage service provider with keys in the eventually consistent database. The key_by_bucket table can include a bucket_id column, a key_prefix column, a generation column, a key column, and a metadata column. The bucket id column identifies a bucket identifier as would be associated with a cloud storage provider. The key_prefix column stores key prefixes that identify a partition, as explained above. The generation column can be used to indicate which stored data is newest. For example, when data is updated, the data may merely be added without replacing older data, and the generation for the added data may be incremented from the generation for the previously stored data. The key column can store the full key for each row. The metadata column stores the actual metadata that can be used to map a file stored at a data storage system to an object identifier. The primary key for this table can be a combination of the bucket_id, key_prefix, generation, and the key.

The disclosed technology can also create a key_prefix_by_bucket table to associate buckets of a storage service with key prefixes. This table can include a bucket_id column, a key_prefix column, a generation column, an active column, and a splitting column. The bucket id column, key_prefix column, and generation column, store information as described above. The active column and the splitting column can store Boolean values indicating whether a row corresponds to active data and/or has a key prefix that is being split, and are described in further detail below. The primary key for this table can be a combination of the bucket id, key_prefix, and the generation. In various embodiments, all key prefixes for a bucket are stored in a single partition. Doing so enables ordered retrieval because it guarantees that all key prefixes are retrieved in sorted order prior to the key query and “roll-up.”

Thus, the disclosed technology is able to provide bucket ordering when using an eventually consistent database without relying on locking features of the underlying database and without interleaving results from multiple partitions.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

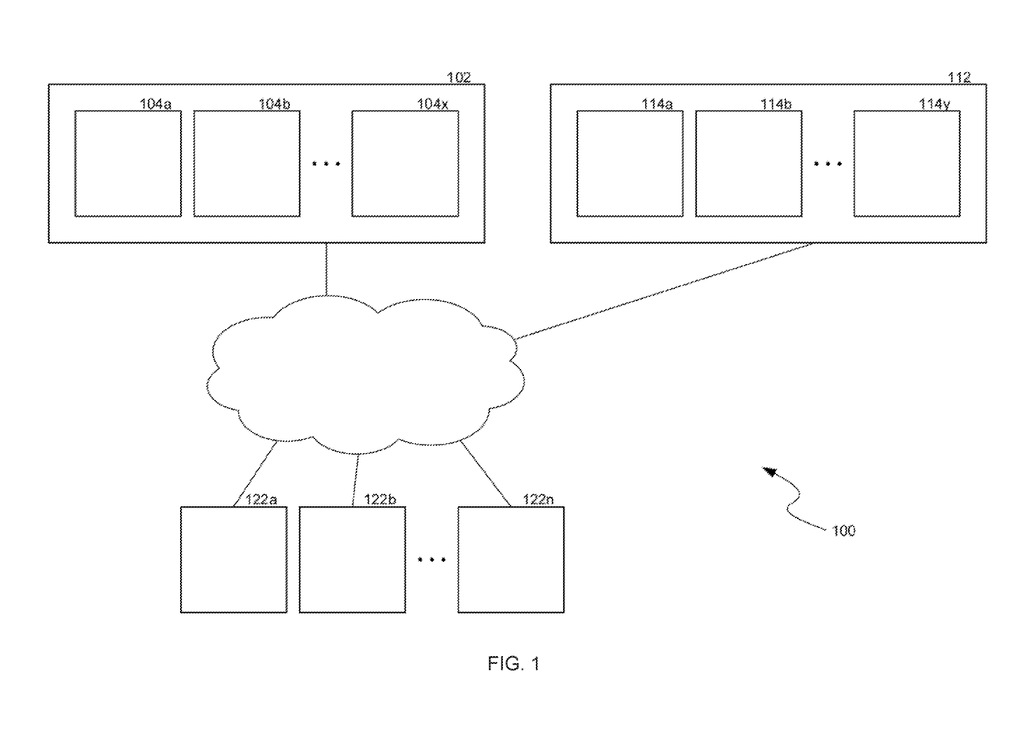

FIG. 1 is a block diagram illustrating an environment 100 in which the disclosed technology may operate in some embodiments. The environment 100 can include server computing devices 102 and server computing devices 112. The server computing devices 102 can be in a first data center and the server computing devices 112 can be in a second, different data center. In various embodiments, the different data centers can include a data center of a cloud data services provider and a data center associated with an entity, e.g., a private data center or a co-hosted data center. As an example, the server computing devices 102 can include “nodes” 104a, 104b, up to 104x. The environment 100 can also include additional server computing devices that are not illustrated. The various data centers can be interconnected via a network 120 to each other and to client computing devices 122a, 122b, 122n, and so forth. The network 120 can be an intranet, the Internet, or a combination of the two.

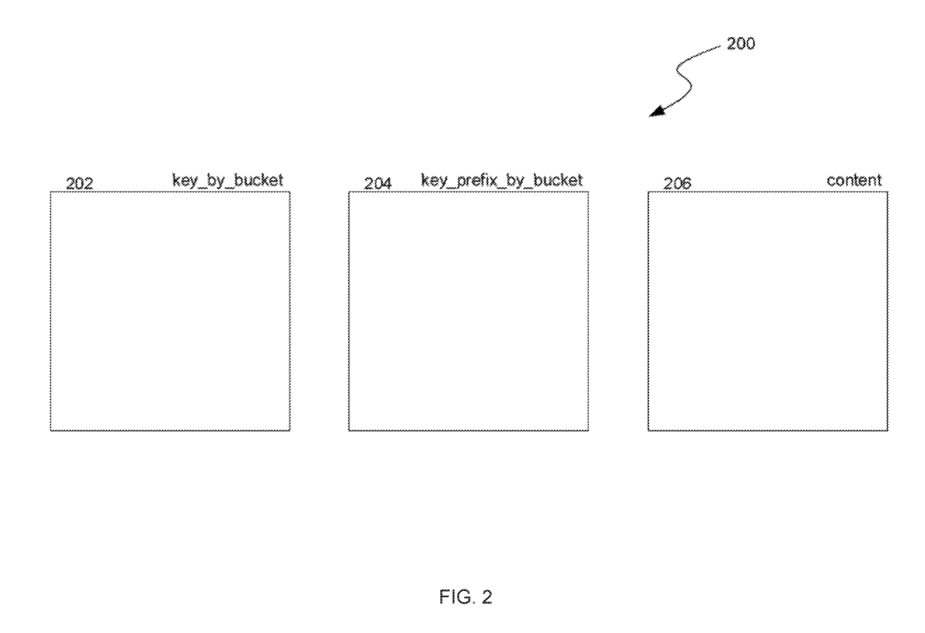

FIG. 2 is a table diagram illustrating tables 200 employed by the disclosed technology in various embodiments. In various embodiments, the tables 200 can include a key by bucket table 202, key_prefix_by_bucket table 204, and content table 206. The key_by_bucket table 202 and the key_prefix_by_bucket table 204 are described above. The content table can be a file system that stores files, a listing of the files (e.g., iNode hierarchy), file allocation table, etc. Each file identified in content table 206 can store an object, and metadata corresponding to the object can be stored in table 202, 204, both, or a different table.

While FIG. 2 illustrates a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

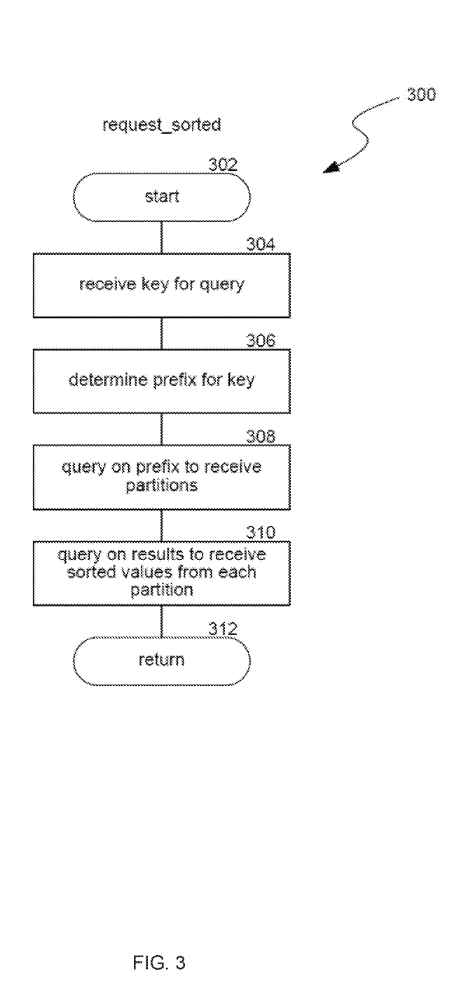

FIG. 3 is a flow diagram illustrating a routine 300 invoked by the disclosed technology in various embodiments. The routine 300 can be used to retrieve sorted data, and begins at block 302. At block 304, the routine 300 receives a key for a query. As an example, the routine 300 may be invoked multiple times to retrieve data. At block 306, the routine 300 determines a key prefix based on the received key. At block 308, the routine uses the key prefix to identify partitions. At block 310, the routine queries each of the partitions to receive sorted values from the partitions. The routine returns at block 312. Because the underlying database may be able to provide sorted values from a partition, the overall data set can be returned in a sorted order.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

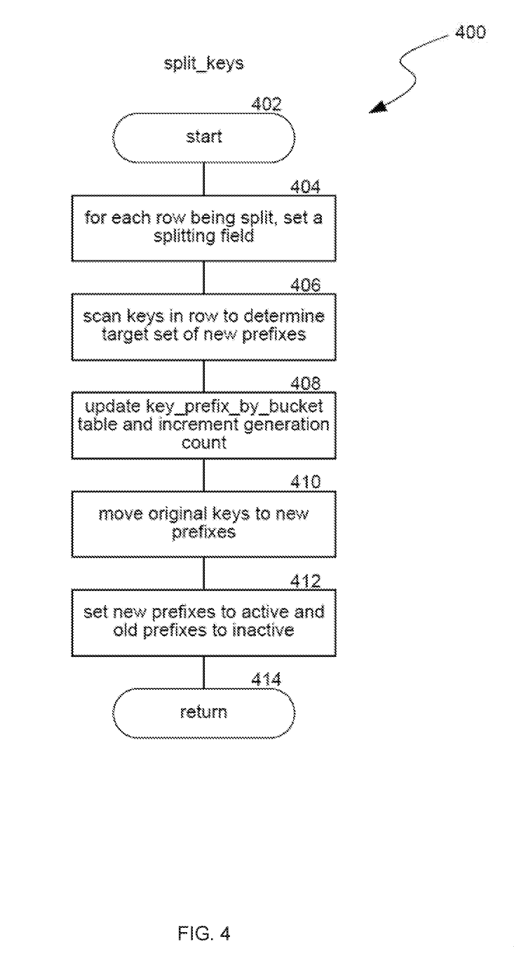

FIG. 4 is a flow diagram illustrating a routine 400 invoked by the disclosed technology in various embodiments. The routine 400 can be invoked to split rows. Rows may need to be split when data is updated or added. For example, the rows may need to be split if the key needs to be changed or the underlying data needs to be moved to a different partition. The routine 400 begins at block 402. At block 404, the routine sets a splitting field Boolean value to true for each row that is being split. At block 406, the routine 400 scans keys in each row to determine a target set of new key prefixes. At block 408, the routine 400 updates the keyprefix_by_bucket table to include the new key prefix(es) and increments its generation count to indicate that the data has changed. At block 410, the routine 400 moves the keys to the new prefixes. At block 412, the routine 400 indicates via an “active” Boolean field that the new prefixes are active and the old prefixes are inactive. The routine returns at block 414.

If the technology receives updates to a row while the row's keys are being split, the update can go to both the old prefix and the new prefix. Doing so can facilitate in mitigation or elimination of race conditions. Queries (e.g., SELECTs) can retrieve data associated with the original prefix until the splitting is complete. In various embodiments, the new prefixes are set to active before the old prefixes are set to inactive. That way, the new data, now active, are returned instead of the old data. Thus, queries can return the highest generation active prefix. Cleanup of deletions can occur at a later time.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

What is claimed:

1. A method performed by a computing device, comprising:
receiving a key for a query;
determining a prefix for the received key;
identifying a partition based on the prefix;
querying data from two or more partitions, each partition stored at a different computing device; and
providing results from the two or more partitions in an ordered manner without interleaving results from the two or more partitions and without employing a locking feature of an underlying database.

2. The method of claim 1, wherein the underlying database is an eventually consistent database.

3. The method of claim 1, wherein the data stored in the partitions enables a mapping of files to an object storage namespace.

4. The method of claim 1, wherein the determining a prefix for a key includes querying a table that stores an association between buckets and keys.

5. The method of claim 4, wherein a bucket corresponds to a container in an object storage namespace.

6. The method of claim 4, wherein the querying includes determining whether a row is active.

7. The method of claim 6, wherein the querying includes determining that the row has the highest generation number.

8. A computer-readable storage memory storing computer-executable instructions, comprising:
instructions for setting a Boolean value indicating that a key is being split;
instructions for scanning keys in a corresponding row to determine a target set of new prefixes;
instructions for updating a key mapping table and incrementing a generation counter;
instructions for moving original keys to new prefix keys; and
instructions for setting new prefix keys to active and old prefix keys to inactive.

9. The computer-readable storage memory of claim 8, wherein the new prefix keys are set to active before the old prefix keys are set to inactive.

10. The computer-readable storage memory of claim 8, wherein in an event an update is received during the splitting, updating both the old prefix keys and the new prefix keys.

11. The computer-readable storage memory of claim 10, wherein upon receiving a SELECT query, data associated with the original prefix keys is returned until the splitting is completed.

12. The computer-readable storage memory of claim 11, further comprising cleaning up deleted data.

13. A system, comprising:
a processor and memory;
a component configured to set a Boolean value indicating that a key is being split;
a component configured to scan keys in a corresponding row to determine a target set of new prefixes;
a component configured to update a key mapping table and incrementing a generation counter;
a component configured to move original keys to new prefix keys; and
a component configured to set new prefix keys to active and old prefix keys to inactive.

14. The system of claim 13, wherein the new prefix keys are set to active before the old prefix keys are set to inactive.

15. The system of claim 13, wherein in an event an update is received during the splitting, updating both the old prefix keys and the new prefix keys.

16. The system of claim 15, wherein upon receiving a SELECT query, data associated with the original prefix keys is returned until the splitting is completed.

17. The system of claim 16, further comprising cleaning up deleted data.
